(19) United States
(12) Patent Application Publication
(10) Pub. No.: US 2025/0084006 A1
(43) Pub. Date: Mar. 13, 2025

(54) QUALITY CONTROL FOR RAW MATERIALS USED IN CONCRETE PRODUCTION

(71) Applicant: Sensolyzer Advanced Sensing Systems Ltd., Herzliya (IL)

(72) Inventor: Yaniv KNOP, Herzliya (IL)

(21) Appl. No.: 18/953,836

(22) Filed: Nov. 20, 2024

Related U.S. Application Data
(63) Continuation-in-part of application No. 18/514,023, filed on Nov. 20, 2023.
Application No. 18/514,023 is a continuation-in-part of application No. PCT/IL2022/050173, filed on Feb. 14, 2022.
(60) Provisional application No. 63/192,693, filed on May 25, 2021.

(51) Int. Cl. C04B 40/00; B28C 7/02; C04B 28/00; C04B 111/00; G05B 13/02

(52) U.S. Cl. CPC C04B 40/0032; B28C 7/024; C04B 28/006; G05B 13/0265; C04B 2111/00181

(57) ABSTRACT

This invention presents a system and method for the real-time, autonomous quality control of raw materials used in concrete production. The system can detect changes in material properties, issue alerts, and autonomously adjust the concrete mixture to compensate for those changes. The system comprises a network of sensors, including cameras, ultrasonic sensors, spectrometers, and temperature sensors, strategically positioned at various points in the concrete production process. An AI-based control system analyzes real-time data from these sensors to determine properties of the raw materials, such as water content, density, particle size distribution, impurities, temperature, and color. The AI system autonomously generates alerts and adjusts the concrete mixture in response to detected deviations from desired specifications, ensuring consistent concrete quality and reducing reliance on manual intervention. This proactive approach optimizes concrete production by improving consistency, reducing the risk of failures due to substandard raw materials, and increasing efficiency.

### CROSS-REFERENCE TO RELATED APPLICATIONS

This application is a Continuation-In-Part of U.S. patent application Ser. No. 18/514,023, filed Nov. 20, 2023, which is a Continuation-In-Part of PCT Application No. PCT/IL2022/050173, filed Feb. 14, 2022, which claims the benefit of U.S. Provisional Patent Application No. 63/192,693, filed May 25, 2021. The contents of which are all incorporate herein by reference in their entirety.

### TECHNICAL FIELD

This invention relates to a system and method for real-time, autonomous quality control of raw materials used in concrete production. The system leverages multiple sensors, image processing, and artificial intelligence to analyse and maintain the quality of raw materials, enabling proactive adjustments to the concrete mixture and ensuring consistent concrete quality.

### BACKGROUND

Concrete, the most widely used construction material globally, is a composite with a complex structure. Its quality hinges on the careful proportioning and interaction of its constituents: water, recycled water, fine aggregates, coarse aggregates, sand, chemical additives, and admixtures, all bound together by cement.

The production of concrete involves sourcing raw materials from various locations, such as quarries for aggregates and sand. These materials are then transported to concrete plants where they undergo further processing and batching. The quality of these raw materials significantly influences the final concrete properties, including its workability, strength, and durability. However, maintaining consistent quality in these raw materials poses several challenges. Aggregates and sand, being natural materials, can vary in size, shape, and composition. They may also contain impurities like clay, dust, or organic matter, which can negatively impact concrete performance.

Traditional quality control methods often rely on manual sampling and testing, which can be time-consuming, labour-intensive, and prone to human error. Moreover, these methods may not adequately capture real-time variations in material properties. Therefore, there is a long-felt need for a more efficient, accurate, and real-time quality control system for concrete raw materials. This invention addresses this need by incorporating multiple sensors, image processing, and artificial intelligence to continuously monitor and analyse raw materials throughout the concrete production process.

WO 2022/249162 A1, which is the publication of the co-pending application by the same inventors, focuses on the visual monitoring of aggregates, sand, and concrete to assess their slump level and homogeneity. The system primarily relies on an imaging or video camera to capture visual information, which is then processed and analysed by a computing unit. The system alerts the user to any deviations in concrete slump level and homogeneity, requiring manual intervention for corrective action. While WO 2022/249162 A1 introduces the concept of visual monitoring in concrete production, it has certain limitations. It primarily focuses on aggregates, sand, and the final concrete mixture, with limited emphasis on other raw materials. The system is reactive rather than proactive, requiring user intervention for any adjustments to the concrete mixture.

The present invention addresses these limitations by incorporating a wider range of sensors, including ultrasonic sensors, image analysis, and spectrometers, to analyse various properties beyond visual appearance. The proactive AI-based control system enables proactive and continuous monitoring and autonomous adjustments to the concrete mixture, ensuring consistent concrete quality without requiring user intervention. The system allows changing concrete mixes according to the properties obtained from the various sensors for all raw materials in real time and automatically.

### SUMMARY

The present invention introduces a groundbreaking system and method for the real-time, autonomous quality control of raw materials used in concrete production. This advancement marks a significant leap forward in concrete quality control by ensuring the consistent quality of raw materials throughout the production process.

In one embodiment, a system for real-time, autonomous quality control of the raw materials comprises a sensor system with at least two sensor types (camera, ultrasonic sensor, spectrometer, and temperature sensor) to monitor various properties of the raw materials. The system also comprises an AI-based control system that receives and analyses real-time sensor data to determine properties such as water content, density, particle size distribution, impurities, temperature, homogeneity, hardness, shape, and colour of raw materials. The AI-based control system autonomously generates alerts and adjusts the concrete mixture in response to real-time data, without the need for user intervention.

In certain embodiments, the system of the invention is configured to analyse a wide range of raw materials, including coarse aggregates, fine aggregates, sand, cement, fly ash, other powder additives, water, recycled water, and all types of chemical admixtures used in concrete production. In other embodiments, the AI-based control system adjusts the concrete mixture by autonomously modifying the ratio of raw materials and controlling the addition of admixtures based on a structured process, real-time sensor data, and loading time. In some embodiments, the system includes a camera to capture images of raw materials, enabling the proactive AI-based control system to analyse particle size distribution, identify impurities, and assess moisture content, uniformity, and homogeneity. In further embodiments, the system utilises an ultrasonic sensor to measure the speed of sound through raw materials, providing insights into their density and structural integrity. In additional embodiments, the system incorporates a spectrometer to determine the chemical composition of raw materials, ensuring the use of correct materials and identifying potential contaminants. In particular embodiments, sensors are strategically placed at various points in the concrete production process, including receiving points for raw materials, storage yards, storage tanks, conveyor belts, and water and admixture lines.

In another aspect of the present invention, the method involves real-time monitoring of raw material properties and quality using a multi-sensor system, analysing real-time sensor data with a proactive AI-based control system to proactively identify potential issues and improve consistency and quality of concrete. The proactive AI system of the invention is configured to determine properties of raw materials, such as water content, solid content, homogeneity, colour, hardness, density, particle size distribution, impurities, and temperature, and generating alerts in response to real-time data. Consequently, proactive AI-based control system allows to reduced risk of failures due to substandard raw materials, and reduce reliance on manual intervention, leading to increased efficiency and reduced labour costs.

The present invention thus revolutionises quality control in the concrete industry by combining multiple sensors, image processing, and proactive AI to ensure the consistent quality of raw materials, leading to improved concrete performance, reduced risks of failures, and increased efficiency in concrete production.

Various embodiments may allow various benefits and may be used in conjunction with various applications. The details of one or more embodiments are set forth in the accompanying figures and the description below. Other features, objects and advantages of the described techniques will be apparent from the description and drawings and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1 shows crushing rocks into aggregates of various sizes in the quarry.

FIG. 2 shows the transport of the aggregates and conveyors of the aggregates of different sizes.

FIG. 3 shows a photo of a yard of aggregates in a concrete plant.

FIG. 4 shows the transport of aggregates on the conveyor belt at the concrete plant.

FIG. 5 shows aggregates of different sizes used for the production of concrete mixtures.

FIG. 6 shows using a set of sieves to examine and control the size of the aggregates.

FIG. 7 shows a 9 to 14 mm size aggregate soiled (contaminated) with a fine powder used in a concrete plant and caused a failure in the quality of the concrete

FIG. 8 shows presence of brown clay blocks in the aggregates intended for concrete production.

FIG. 9 is a schematic diagram illustrating the overall system architecture, including the sensor system, AI-based control system, and their interaction with the concrete production process.

FIG. 10 is a schematic view of the sensor system, showing the different types of sensors (camera, ultrasonic sensor, spectrometer, temperature sensor) and their placement at various points in the concrete production process (receiving points, conveyor belts, storage areas, water and admixture lines).

FIG. 11 is a diagram showing the image processing and analysis by the AI-based control system designed to analyse images captured by the camera and to determine particle size distribution of raw materials.

FIGS. 12A, 12C and 12E show the images of the aggregates having different sizes, recorded with a camera.

FIGS. 12B, 12D and 12F show the corresponding segmented images processed with the AI-based control system of the invention, marking the boundaries of the aggregates. The histogram showing the size distribution of the aggregates obtained from these images is not shown here.

FIG. 13 shows the particle size distribution histogram generated by the AI-powered system of the invention from the segmented images in FIGS. 12B, 12D and 12F.

FIG. 14 illustrates how the AI-based control system identifies impurities within raw materials using image analysis.

FIGS. 15A and 15B show the detection of clay impurities in aggregates by detecting the changes in the hue shades of the image (indicated by the red dots in the image).

FIG. 16 is a depiction of the AI-based control system assessing moisture content, uniformity, and homogeneity of raw materials through image analysis.

FIGS. 17A and 17B visualise moisture content in aggregates using AI-powered image analysis of the present invention for two samples 3305 and 1989, respectively.

### DETAILED DESCRIPTION

In the following description, various aspects of the present application will be described. For purposes of explanation, specific details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising x and z” should not be limited to devices consisting only of components x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5,as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

By definition, “aggregates” are granular materials, such as sand, gravel, crushed stone, and slag, used with a cementing medium to form concrete or mortar. “Artificial Intelligence (AI)” is the ability of a computer or a robot controlled by a computer to perform tasks that are usually done by humans because they require human intelligence and discernment. As defined herein, “autonomous” means acting independently or having the freedom to do so. “Cement” is a powdery substance made with calcined lime and clay. It is mixed with water to form mortar or mixed with sand, gravel, and water to make concrete. As used herein, “chemical admixtures” are ingredients added to concrete before or during mixing to modify its properties, such as workability, setting time, or durability. “Concrete” is a composite material composed of aggregates (sand, gravel, crushed stone) bound together by a cementing medium (typically Portland cement and water).

“Image processing” is defined herein as analysing and manipulating images to extract meaningful information or enhance visual quality. “Impurities” are defined herein as unwanted substances or particles present in raw materials that can negatively affect concrete quality. By definition, “particle size distribution” is the range of sizes of individual particles in a granular material, such as aggregates or sand, affecting the workability and packing density of concrete. As used herein, “proactive” means acting in anticipation of future issues, needs, or changes. The term “raw materials” stands for the basic materials used in the production of concrete, including aggregates, sand, cement, water, and chemical admixtures. “Real-time” means occurring immediately, with no significant delay between the time an event happens and the time it is reported or responded to.

As defined herein, “sensor system” is a collection of sensors used to detect and measure physical phenomena, such as temperature, pressure, or chemical composition. “Spectrometer” is an analytical instrument used for measuring and recording the spectrum of electromagnetic radiation. “Ultrasonic sensor” is a device that measures distance by emitting sound waves and measuring the time it takes for the echo to return.

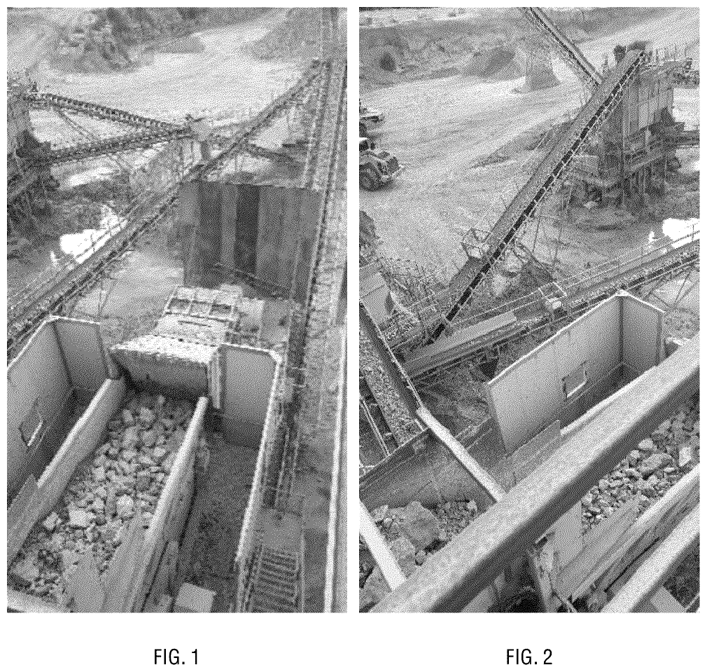

Manufacturing of concrete and concrete mixes start at quarries, where aggregates and sand of different sizes are produced and processed. Reference is made to FIG. 1 showing crushing rocks into aggregates of various sizes in the quarry. After the crushing process, the aggregates are separated by a set of sieves and stacked in different piles according to the different sizes. FIG. 2 shows the transport of the aggregates and conveyors of the aggregates of different sizes. The aggregates and sand are transported to the concrete plant for the purpose of producing the concrete. The concrete plant uses four to five types of aggregates and sand to produce concrete mixtures, usually having particle size of 25 mm and below.

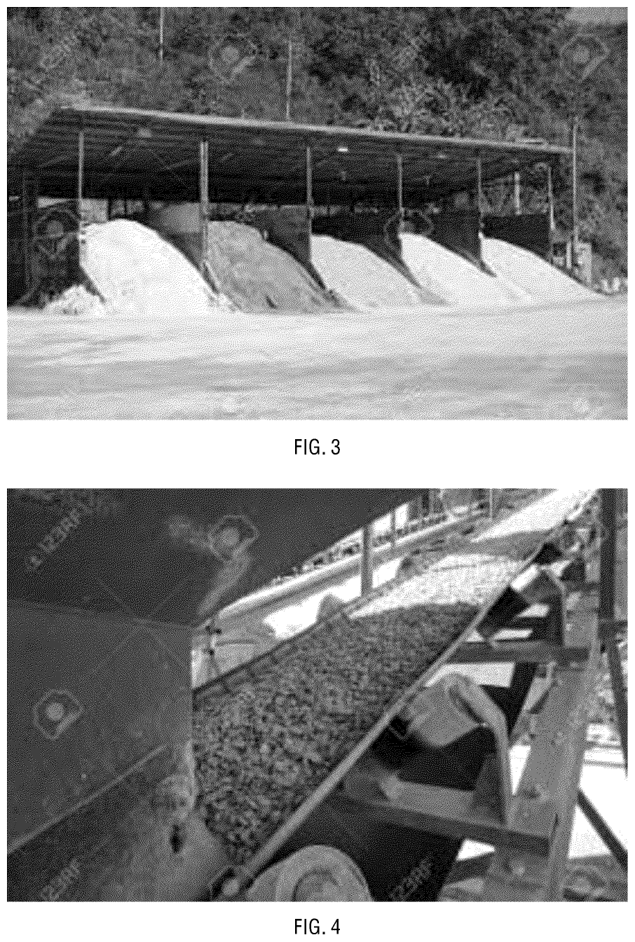

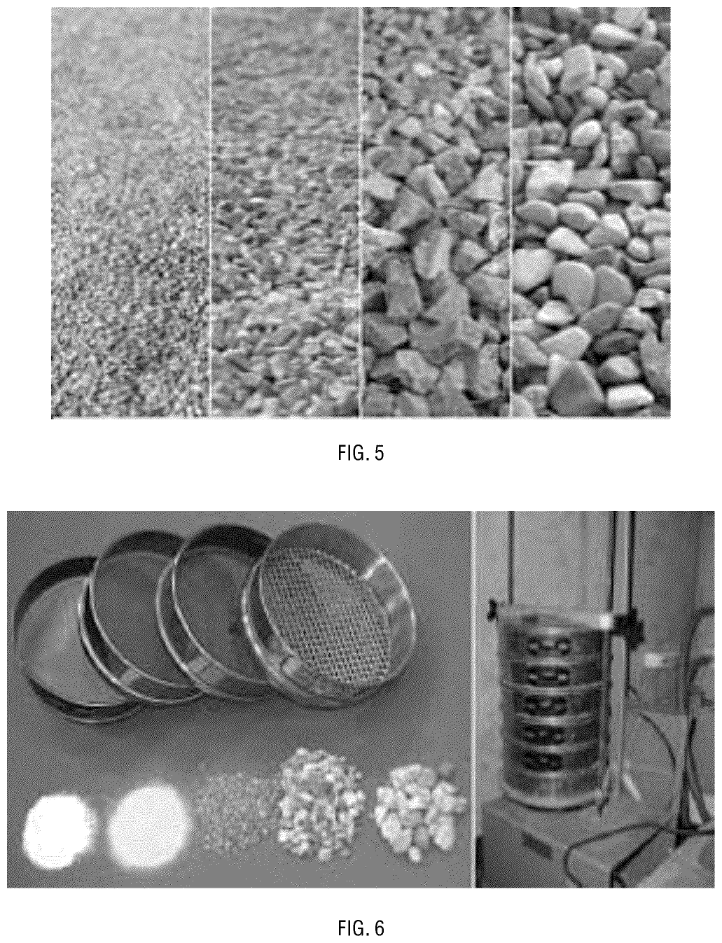

FIG. 3 shows a picture of an aggregate yard at a concrete plant. From the aggregate yard at the concrete plant, the aggregates are transferred on an aggregate conveyor to the concrete mixer. This allows for the production of concrete by mixing the aggregates, cement, water, and chemical additives and admixtures to produce a homogeneous concrete mixture. FIG. 4 shows the transport of aggregates on the conveyor belt. The aggregates and sand are transported from a quarry and differ from each other mainly in their size. FIG. 5 shows aggregates of different sizes used for the production of concrete mixtures. The size of the aggregates is examined in a laboratory by filtering an aggregate sample using a set of sieves, as seen in FIG. 6.

Because the aggregates are a natural material that is crushed, they come in several sizes and are often contaminated with dust and other impurities that affect the quality of the concrete. In addition, there are changes in the moisture content of the aggregates depending on the weather, their washing, and changes in density that significantly alter the properties of the fresh and hardened concrete. Using the proactive AI-powered system of the present invention, which is a quality control system that autonomously performs the analysis of raw materials in real time, such as water content, density, particle size distribution, impurities, temperature, homogeneity, hardness, shape, and colour of the raw materials, it is possible to control their quality in the quarry. This also acts as a tool for ongoing quality control and control of the raw materials received at the concrete plant.

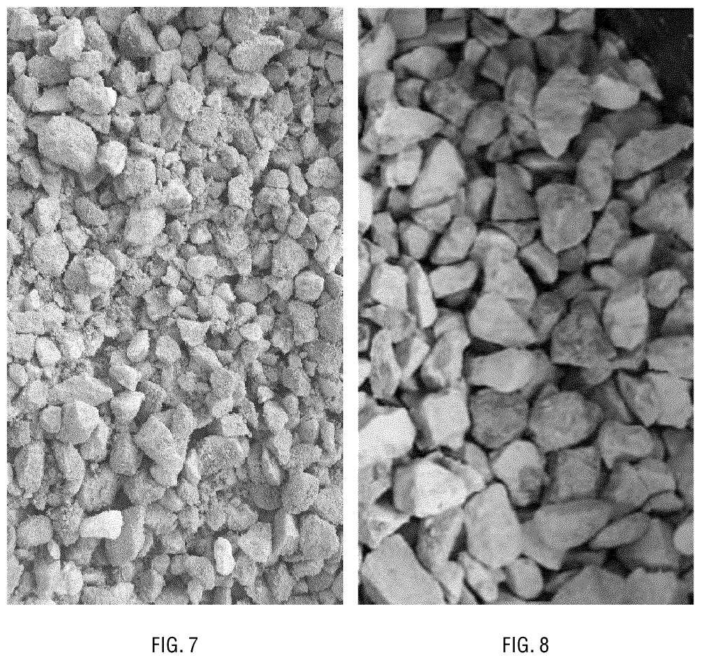

The system of the present invention is capable of autonomously monitoring the properties of the raw materials, for example, examine for an excess moisture of aggregates and sand on rainy days, an excessive aggregate size split or the presence of contaminants or dust content that exceeds the allowable amount. The system will send an alert if it receives an irregular aggregate size distribution or if there are contaminants or dust content that exceeds the permitted amount. It will also examine for the presence of excess moisture in aggregates (on rainy days). FIG. 7 shows an aggregate with a size of 9 to 14 mm that is contaminated with fine powder. This aggregate was used in a concrete plant and caused a failure in the quality of the concrete. FIG. 8 shows the presence of brown clay blocks in the aggregates. Clay blocks severely impair the quality of the concrete.

According to the first aspect of the present invention, a system for real-time, autonomous quality control of raw materials used in concrete production, comprises:
1) A sensor system configured to monitor properties of the raw materials, the sensor system including at least two sensors selected from a camera, an ultrasonic sensor, a spectrometer, and a temperature sensor; and
2) A proactive artificial intelligence (AI)-based control system configured to:
   receive real-time sensor data from the sensor system;
   analyse the real-time sensor data to determine one or more properties of the raw materials, the properties including water content, solid content density, particle size distribution, impurities, temperature, homogeneity, hardness, shape, and colour of the raw materials; and
   autonomously generate an alert and adjust a concrete mixture in response to the real-time sensor data without requiring user intervention,
   wherein the proactive AI-based control system adjusts the concrete mixture by adjusting a ratio of the raw materials and by controlling addition of admixtures according to a structured process and according to the data received from the sensor system.

In some embodiments, the raw materials include at least one of coarse aggregates, fine aggregates, sand, cement, fly ash, and other powder additives, water and recycled water, and all types of chemical admixtures used in the concrete plant. In another embodiment, the proactive AI-based control system is further configured to adjust the concrete mixture based on loading time.

Thus, the invention presents a novel system for achieving real-time, autonomous quality control of raw materials used in concrete production and changing the composition of the concrete mix according to the changes that will occur in the properties of the raw materials. The invention addresses the limitations of traditional quality control methods by providing a proactive, AI-driven solution that ensures consistent raw material quality and, consequently, improved concrete performance. The AI-based control system of the present invention receives and analyses real-time sensor data to determine properties of the raw materials, such as water content, density, particle size distribution, impurities, temperature, homogeneity, hardness, shape, and colour of raw materials, and autonomously generates alerts, and adjusts the concrete mixture in response to real-time data, without the need for user intervention.

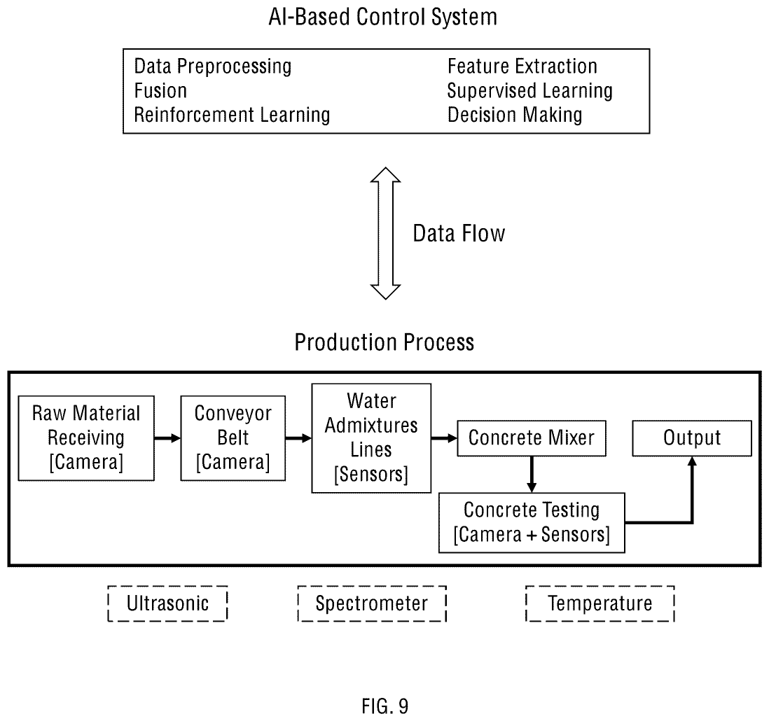

Reference is made to FIG. 9 showing a schematic diagram illustrating the overall system architecture, including the sensor system, proactive AI-based control system, and their interaction with the concrete production process. The top box represents the AI-based control system with its key modules, which will be discussed next. The bottom box represents the simplified concrete production process. The dashed boxes at the bottom of the figure under the concrete production process indicate sensor locations. Arrows indicate the flow of data and control signals.

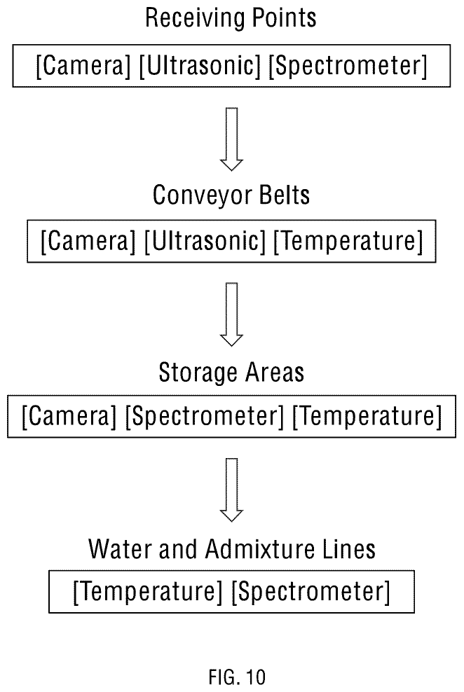

FIG. 10 is a schematic view of the sensor system, showing the different types of sensors (camera, ultrasonic sensor, spectrometer, temperature sensor) and their placement at various points in the concrete production process (receiving points, conveyor belts, storage areas, water and admixture lines). Each vertical section represents a different stage in the concrete production process (from receiving points to water and admixtures line). Square brackets in the boxes indicate the types of sensors placed at each stage. The arrangement of sensors highlights the comprehensive monitoring of raw materials throughout the process.

In detail, the system of the invention comprises two main components:
1) Sensor System: A network of sensors strategically positioned at various points in the concrete production process, including:
   Receiving points for raw materials;
   Storage yards;
   Storage tanks;
   Conveyor belts; and
   Water and recycled water, and admixture lines.
2) AI-Based Control System: A proactive AI-powered system that receives real-time sensor data, analyses it, and makes autonomous decisions to maintain the desired quality of the concrete mixture.

The sensor system of the invention includes at least two types of sensors selected from cameras configured to capture images of the raw materials for visual analysis; ultrasonic sensors suitable for measuring the speed of sound through the raw materials to assess density and structural integrity; spectrometers designed to analyse the chemical composition of the raw materials to identify potential contaminants and ensure the use of correct materials, and temperature sensors suitable for monitoring the temperature of both solid and liquid raw materials to ensure they are within the acceptable range for concrete production.

The proactive AI-based control system is an intelligent system that receives real-time sensor data, analyses it, and makes autonomous decisions to maintain the desired quality of the concrete mixture. It is configured to:
Monitor Raw Materials: Continuously monitor the properties of various raw materials, including coarse and fine aggregates, sand, cement, fly ash, other powder additives, water, recycled water, and all types of chemical admixtures.
Analyse Sensor Data: Analyse the real-time data from the sensor system to determine properties such as water content, solid content density, particle size distribution, impurities, temperature, homogeneity, hardness, shape, and colour of the raw materials.
Generate Alerts: If any deviations from the desired specifications are detected, the proactive AI-based control system generates alerts to notify operators of potential issues.
Autonomously Adjust Concrete Mixture: The key feature of this invention is the ability of the AI-based control system to autonomously adjust the concrete mixture without requiring user intervention. This is achieved by adjusting the ratio of raw materials in the mixture, controlling the addition of admixtures to modify the properties of the concrete, and taking into account the loading time of the concrete mixture.

This proactive and autonomous control ensures consistent concrete quality and minimises the risk of failures due to substandard raw materials. The cameras in the sensor system capture images of the raw materials at various stages of the production process. The proactive AI-based control system then analyses these images to:
Determine Particle Size Distribution. The AI system identifies the size and distribution of particles in aggregates and sand, which is crucial for achieving the desired workability and strength of the concrete.
Identify Impurities. The system detects the presence of impurities such as clay, dust, or organic matter in the raw materials, which can negatively impact concrete quality.
Assess Moisture Content, Uniformity, and Homogeneity. The AI system analyses images to determine the moisture content of aggregates and sand, ensuring it is within the acceptable range for concrete production. It also assesses the uniformity and homogeneity of the raw materials to ensure consistent quality.

By definition, proactive AI is an artificial intelligence system that anticipates and fulfils the needs of users without prompting. This type of AI uses the latest algorithms, machine learning (ML), and predictive analytics to forecast future commands and proactively respond to them. Reactive AI operates in the moment. It analyses incoming data, compares it to its knowledge base, and then reacts accordingly. It can be thought as a reflex action. It does not predict or anticipate future events; it simply responds to the current situation. In contrast, proactive AI, on the other hand, anticipates future needs and events. It leverages historical data, predictive models, and real-time information to make decisions and take action before an event occurs. This allows it to optimise processes, prevent problems, and capitalise on opportunities. Reactive AI focuses on reacting to current situations, whereas proactive AI anticipates and prevents future events. Reactive AI uses primarily current data and makes decisions based on immediate context, whereas proactive AI uses historical, real-time, and predictive data and makes decisions based on predictions and long-term goals. Thus, reactive AI only responds to events, whereas proactive AI initiates actions.

According to one embodiment, the AI-based control system includes a camera configured to capture images of the raw materials, the AI-based control system being configured to analyse the images to determine particle size distribution of the raw materials. According to another embodiment, the AI-based control system includes a camera configured to capture images of the raw materials, the AI-based control system being configured to analyse the images to identify impurities within the raw materials. According to a further embodiment, the AI-based control system includes a camera configured to capture images of the raw materials, the AI-based control system being configured to analyse the images to assess moisture content, uniformity, and homogeneity of the raw materials and deviation from defined values.

In a further embodiment, the AI-based control system includes an ultrasonic sensor configured to measure a speed of sound through the raw materials. This provides valuable information about the density and structural integrity of the materials, which are important factors in determining the strength and durability of the concrete. In yet further embodiment, the AI-based control system includes a spectrometer configured to determine a chemical composition of the raw materials, uniformity, homogeneity of the raw materials and deviation from defined values. This helps to identify potential contaminants, i.e., the system can detect the presence of unwanted chemicals or minerals that could negatively affect the properties of the concrete. In addition, this ensures the use of correct materials, i.e., the system verifies that the correct type and grade of materials are being used in the concrete mixture, preventing errors and ensuring consistency.

The proactive AI system in the present invention employs a sophisticated algorithm that fuses data from multiple sensors to provide a comprehensive understanding of the raw materials' state. This algorithm incorporates:
a) Data Preprocessing: Raw sensor data is cleaned and pre-processed to handle noise, inconsistencies, and missing values. This ensures that the AI system receives reliable and consistent input for accurate analysis.
b) Feature Extraction: Relevant features are extracted from the pre-processed data. For image data, this involves techniques like edge detection, object recognition, and texture analysis to identify particle size distribution, impurities, and other visual characteristics. For ultrasonic and spectrometer data, this involves signal processing and pattern recognition to extract meaningful information about density, chemical composition, and other properties.
c) Machine Learning Model: A machine learning model, specifically a hybrid model combining reinforcement learning (RL) and supervised learning (SL), is employed to analyse the extracted features and make decisions.
d) Decision-Making: The AI system fuses the predictions from the SL model with the adaptive learning capabilities of the RL agent to make real-time decisions. This involves:
   Predicting the optimal concrete mix design based on current raw material properties using the SL model.
   Evaluating potential adjustments to the raw material ratios and admixture additions.
   Simulating the impact of these adjustments on the final concrete properties.
   Selecting the adjustments that maximize concrete quality and resource efficiency, guided by the RL agent's learning.
e) Autonomous Control: The AI system then sends commands to the concrete production system to implement the selected adjustments. This includes:
   Modifying the proportions of raw materials being fed into the mixer.
   Controlling the timing and quantity of admixture additions.
   Generating alerts for manual intervention if necessary, such as when raw material quality falls significantly below acceptable thresholds.

Thus, the proactive AI model of the present invention is a hybrid model containing two components: supervised learning (SL) and reinforcement learning (RL), which are crucial to the proactive and adaptive nature of the AI system. An SL model is trained on a labelled dataset of historical raw material data with corresponding desired concrete mix designs. This model learns to predict the optimal concrete mix design based on the raw material properties. That is, in the SL, a large dataset is compiled, containing historical records of raw material properties and corresponding successful concrete mix designs. This data is meticulously labelled, with each data point containing: (i) input features including raw material properties like aggregate size distribution, moisture content, cement type, admixture types and quantities, etc., extracted from sensor data (images, spectrometer readings, etc.), and (ii) output labels including corresponding concrete mix designs (proportions of each raw material) that resulted in the desired concrete properties (strength, workability, setting time, etc.).

This labelled dataset is used to train a supervised learning model, often a regression model. Popular choices include:
Artificial Neural Networks (ANNs), which can learn complex non-linear relationships between raw material properties and concrete mix designs.
Random Forests, which is an ensemble learning method that combines multiple decision trees to improve prediction accuracy and robustness.
Support Vector Machines (SVMs), which are effective for high-dimensional data and can handle non-linear relationships using kernel functions.

The trained SL model is validated on a separate dataset to evaluate its performance and ensure it generalises well to unseen data. Techniques like cross-validation and hyperparameter tuning are used to optimize the model's accuracy and prevent overfitting. Once trained and validated, the SL model can predict the optimal concrete mix design for new, unseen raw material data. This provides a starting point for the AI system's decision-making process.

An RL agent learns through trial and error by interacting with the concrete production environment. It receives rewards for producing concrete that meets the desired specifications and penalties for deviations or inefficient use of resources. This allows the RL agent to adapt to new situations and optimise the concrete mix design over time. Therefore, the concrete production process is modelled as an RL environment. This includes the state, actions and rewards. The state is actually the current state of the environment, defined by the raw material properties, current mix design, and any other relevant factors (e.g., ambient temperature, humidity). The possible actions the RL agent can take, such as adjusting the proportions of raw materials or adding admixtures. A reward function that quantifies the desirability of the concrete produced. Rewards are given for producing concrete that meets the desired specifications (strength, workability, etc.) and penalties for deviations or inefficient use of resources.

The RL agent interacts with the environment by taking actions and observing the resulting states and rewards. It learns to optimise its actions to maximise cumulative rewards over time. The RL agent uses a learning algorithm, such as Q-learning or Deep Q-Networks (DQNs), to update its knowledge about the environment and improve its decision-making. Further, the RL agent balances exploration (trying new actions to discover better strategies) and exploitation (using its current knowledge to select the best-known actions) to achieve optimal performance.

There is an essential synergy between SL and RL in the proactive AI hybrid model of the present invention. The SL model provides a good initial estimate of the optimal concrete mix design based on historical data. However, the RL agent adds adaptability and the ability to learn from new experiences and optimize the mix design in real-time. This combined approach allows the AI system to handle variations and uncertainties in raw materials, adapt to changing environmental conditions, and continuously improve the efficiency and quality of concrete production. This showcases the sophisticated proactive AI algorithms that power the real-time decision-making and autonomous control of the invention.

In yet further embodiment of the present invention, the proactive AI comprises at least one of the following deep layers:
(1) Input Layer receiving pre-processed sensor data for each sensor type:
   Image data including processed image features like edge maps, texture descriptors, object locations, and identified impurities from the Convolutional Neural Networks (CNNs), which are used to extract features from the raw images. Different layers in the CNN learn to detect edges, corners, textures, and eventually, higher-level features like the presence of specific impurities or the distribution of aggregate sizes. For example, outputs from the CNN might include feature maps highlighting edges, texture descriptors, object locations (e.g., bounding boxes around impurities), and classification scores for different types of impurities.
   Ultrasonic data including processed acoustic features like signal strength, time-of-flight, and frequency spectrum from the ultrasonic sensors. Recurrent Neural Networks (RNNs) are used here for temporal analysis. RNNs can analyse the ultrasonic signals over time, capturing dynamic changes in density or structural integrity. This is particularly useful for detecting anomalies or trends that might not be apparent from a single snapshot. For example, RNN outputs might include time-series features like moving averages, trends, and anomaly scores.
   Spectrometer data including processed spectral features like peak intensities, wavelengths, and chemical fingerprints from the spectrometers. Multilayer Perceptrons (MLPs) are used here for pattern recognition. MLPs can identify patterns and classify the chemical composition of the raw materials based on the spectrometer data. For example, MLP outputs could include classification probabilities for different material types, concentrations of specific elements, and anomaly scores for unusual chemical signatures.
   Other Sensor Data including temperature readings, moisture levels, etc., from other sensors.
(2) Fusion Layer combines the diverse features from the different sensors from the input layer into a unified representation. It is more sophisticated to handle the diverse feature types:
   Embedding: Each feature type (image features, ultrasonic features, spectrometer features, etc.) is embedded into a lower-dimensional space using techniques like Principal Component Analysis (PCA) or autoencoders. This helps align the different feature spaces and reduce dimensionality.
   Attention Mechanism: An attention mechanism is used to dynamically weigh the importance of different features based on the current context. For example, if the image analysis detects a high concentration of impurities, the attention mechanism might give more weight to the image features and spectrometer features while down-weighting the ultrasonic features.
   MLP or other Fusion Networks (e.g., a graph neural network) learn to combine the embedded features and attention weights to create a unified representation of the raw material state.
(3) Supervised Learning Layer consists of the trained supervised learning model (e.g., ANN, Random Forest) and receives the rich, fused feature representation from the fusion layer. The SL model predicts and outputs the final concrete properties (strength, workability, setting time, etc.) based on the current raw material characteristics and suggests a concrete mix design (proportions of raw materials) that is likely to achieve the desired concrete properties.
(4) Reinforcement Learning Layer houses the reinforcement learning agent and receives the current state of the environment, including the fused feature representation from the fusion layer, the suggested mix design from the SL layer, other relevant factors (e.g., ambient temperature), and potentially additional context (e.g., historical trends, weather data). This allows the RL agent to make more informed decisions about adjusting the concrete mix. The reward is a feedback on the quality and efficiency of the previous concrete batch, based on how well it met the desired specifications and resource utilisation. The RL agent uses this information to:
   a) evaluate potential actions, i.e., assess the potential impact of different actions (adjusting raw material ratios, adding admixtures) on the final concrete properties and resource efficiency; and
   b) select optimal action, i.e., choose the action that is most likely to maximize long-term rewards, balancing exploration and exploitation.
(5) Output Layer translates the selected action from the RL layer into control signals for the concrete production system. This involves adjusting the setpoints of feeders controlling the flow of raw materials, activating pumps and valves to add admixtures, and sending alerts to operators if manual intervention is required.

By incorporating CNNs, RNNs, and MLPs with specific feature extraction and fusion techniques, the proactive AI system of the invention gains a deeper understanding of the raw materials and their dynamic interactions. This enhances its ability to make accurate predictions, adapt to changing conditions, and optimise concrete production in real-time. In addition, pre-training CNNs on large image datasets significantly improves the overall performance. If data is limited, transfer learning from related domains (e.g., material science) can help initialise the models. In order to understand the AI's decision-making process, techniques like attention mechanisms or model-agnostic explanations can be incorporated. Safeguards are implemented to prevent unsafe or undesirable actions. In addition, the AI model of the present invention is robust to noisy or incomplete sensor data.

All the aforementioned layers are interconnected, with information flowing between them. For example, the RL agent's actions influence the state of the environment, which is then fed back into the system. The system incorporates feedback loops to continuously monitor the actual concrete properties and adjust the AI's decision-making accordingly. This allows the system to adapt to unexpected variations and optimise performance over time. This deep layered architecture allows the proactive AI system to effectively analyse complex data, learn from experience, and make intelligent, real-time decisions to optimise concrete production. This sophisticated AI system enables proactive and adaptive control of the concrete production process, ensuring consistent concrete quality and efficient use of resources.

To sum up, the proactive AI system of the invention receives a diverse range of inputs, which can be categorised as:
A. Real-time sensor data, which is the primary source of information for the AI system. The various sensors provide raw data about the raw materials, which is then pre-processed and analysed by the Al. This data includes images captured by cameras strategically positioned at receiving points, conveyor belts, and storage areas; ultrasonic signals from ultrasonic sensors measuring the speed of sound through the raw materials; spectral readings from spectrometers analysing the chemical composition of the raw materials; other sensor readings including temperature, moisture levels, and other relevant data from additional sensors.
B. Historical Data about raw material properties, concrete mix designs, and corresponding concrete test results. This data is used to train the supervised learning component of the AI and provide context for decision-making.
C. External Data: In some embodiments, the AI system might incorporate external data sources, such as weather information or real-time updates on material prices. This can help in making more informed decisions about the concrete mix design.

The output of the proactive AI system is primarily focused on controlling and adjusting the concrete production process to ensure optimal quality. This output includes:
(a) Alerts and Notifications: The AI system generates alerts and notifications to inform operators of any deviations from the desired specifications or potential issues with the raw materials.
(b) Control Signals: The AI system sends control signals to the concrete production system to adjust the mixture in real-time. This includes:
(c) Adjusting Raw Material Ratios: Modifying the proportions of different raw materials (aggregates, sand, cement, etc.) being fed into the mixer.
(d) Controlling Admixture Additions: Regulating the timing and quantity of chemical admixtures added to the concrete mix.
(e) Mix Design Recommendations: The AI system can provide recommendations for the optimal mix design based on the current raw material properties and desired concrete characteristics.
(f) Reports and Logs: The AI system can generate reports and logs that document the raw material quality, adjustments made to the concrete mix, and the overall performance of the concrete production process.

The combination of these inputs and outputs enables the proactive AI system to effectively, autonomously monitor, analyse, and control the concrete production process, ensuring consistent concrete quality and efficient use of resources.

The AI workflow of the present invention can be visualised as a continuous cycle of monitoring, analysis, decision-making, and control. Therefore, the method of the present invention for real-time, autonomous quality control of raw materials used in concrete production comprises the following steps:
I. Monitoring, using a sensor system, properties of the raw materials, the sensor system including at least two sensors selected from a camera, an ultrasonic sensor, a spectrometer, and a temperature sensor;
II. Analysing, using a proactive artificial intelligence (AI)-based control system, real-time sensor data from the sensor system;
III. Determining, using the proactive AI-based control system, one or more properties of the raw materials, the properties including water content, solid content, homogeneity, colour, hardness, density, particle size distribution, impurities, and temperature of the raw materials; and
IV. Autonomously generating an alert using the proactive AI-based control system in response to the real-time sensor data without requiring user intervention, wherein the AI-based control system adjusts a concrete mixture by adjusting a ratio of the raw materials and by controlling addition of admixtures according to a structured process and according to the data received from the sensor system.

Thus, the AI workflow of the present invention comprises the following key steps:

### Step 1: Data Acquisition and Preprocessing

Real-time Data Collection: The sensor system continuously gathers data from various sources, including cameras, ultrasonic sensors, spectrometers, and other sensors.
Data Preprocessing: This raw sensor data is pre-processed to handle noise, inconsistencies, and missing values. This involves filtering, normalisation, and data cleaning techniques.
Feature Extraction: Relevant features are extracted from the pre-processed data. This involves:
   Image Analysis: Using CNNs to extract features like edges, textures, object locations, and impurity classifications from images.
   Ultrasonic Signal Processing: Using RNNs to analyse temporal patterns and extract features like moving averages, trends, and anomaly scores from ultrasonic signals.
   Spectrometer Data Analysis: Using MLPs to identify patterns and classify the chemical composition from spectrometer readings.

### Step 2: Data Fusion and State Representation

Feature Embedding: Features from different sensors are embedded into a lower-dimensional space using techniques like PCA or autoencoders.
Attention Mechanism: An attention mechanism dynamically weighs the importance of different features based on the current context.
Fusion Network: An MLP or another fusion network combines the embedded features and attention weights to create a unified representation of the raw material state.
State Representation: This fused representation, along with other relevant information (e.g., historical data, external data), forms the current state of the environment for the RL agent.

### Step 3: Supervised Learning Prediction

The trained supervised learning model (e.g., ANN, Random Forest) receives the fused feature representation and predicts the optimal concrete mix design based on historical data.

### Step 4: Reinforcement Learning Decision-Making

Action Evaluation: The RL agent evaluates potential actions (adjusting raw material ratios, adding admixtures) and their impact on the predicted concrete properties and resource efficiency.
Action Selection: The RL agent selects the action that is expected to maximize long-term rewards, balancing exploration and exploitation.

### Step 5: Control and Adjustment

Control Signal Generation: The selected action is translated into control signals for the concrete production system.
Real-time Adjustment: The concrete mixture is adjusted in real-time by modifying raw material proportions and admixture additions.

### Step 6: Monitoring and Feedback

Continuous Monitoring: The sensor system continues to monitor the raw materials and the concrete mixture.
Feedback Loop: The actual concrete properties are compared with the desired specifications, and the feedback is used to update the AI system's knowledge and improve its decision-making over time.

This cyclical workflow enables the proactive AI system to continuously learn and adapt, ensuring consistent concrete quality and efficient resource utilization in the face of varying raw materials and environmental conditions.

Thus, in some embodiments, the method of the present invention further comprises adjusting the concrete mixture by changing the composition of coarse and fine aggregates, sand, cement, coal ash, and other mineral additives. In a particular embodiment, wherein the AI-based control system of the invention includes a camera, the method further comprises capturing images of the raw materials and analysing the images to determine particle size distribution of the raw materials. In another particular embodiment, wherein the AI-based control system includes a camera, the method further comprises capturing images of the raw materials and analysing the images to identify impurities within the raw materials.

In a further embodiment, wherein the AI-based control system includes a camera, the method further comprising capturing images of the raw materials and analysing the images to assess moisture content of the raw materials. In yet further embodiment, wherein the AI-based control system includes an ultrasonic sensor, the method further comprising measuring a speed of sound through the raw materials to determine density and structural integrity of the raw materials. In a specific embodiment, wherein the AI-based control system includes a spectrometer, the method further comprising determining a chemical composition of the raw materials.

The system of the present invention can be placed in the quarry or at the production facility of the raw materials. In an additional embodiment, the method of the present invention further comprises:
(i) receiving the raw materials at a receiving point;
(ii) placing the raw materials on a conveyor belt; and
(iii) adding water and additives to the raw materials at a water and additive line.

According to an additional aspect, computer program product of the invention comprises a non-transitory computer-readable medium storing instructions which, when executed by a processor, cause the processor to perform the method of the present invention.

### EXAMPLES

### Example 1: Image Processing and Analysis for Particle Size Distribution

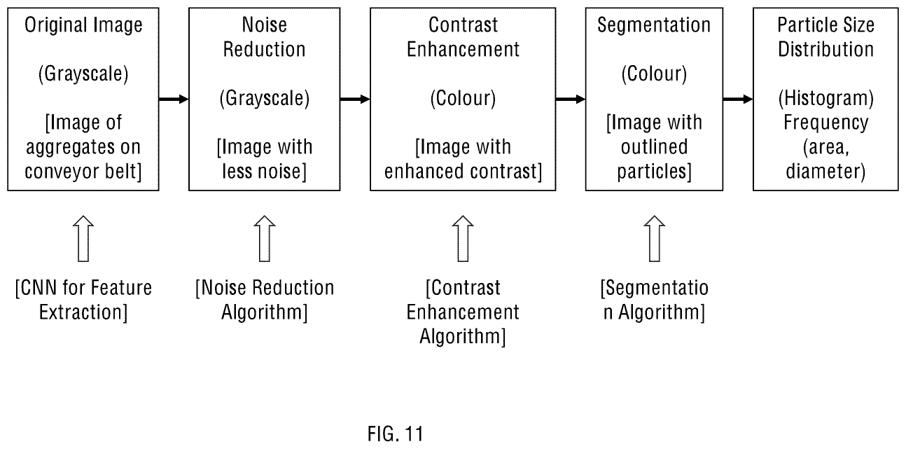

FIG. 11 is a diagram showing the image processing and analysis by the AI-based control system of the invention designed to analyse images captured by the camera and to determine particle size distribution of raw materials. The figure is represented as a series of image processing steps. Each box depicts a stage in the process, with a simplified visual representation. Textual descriptions within the boxes clarify the content of each stage. Black arrows indicate the flow of the process. Annotations below the boxes describe the techniques used in each step.

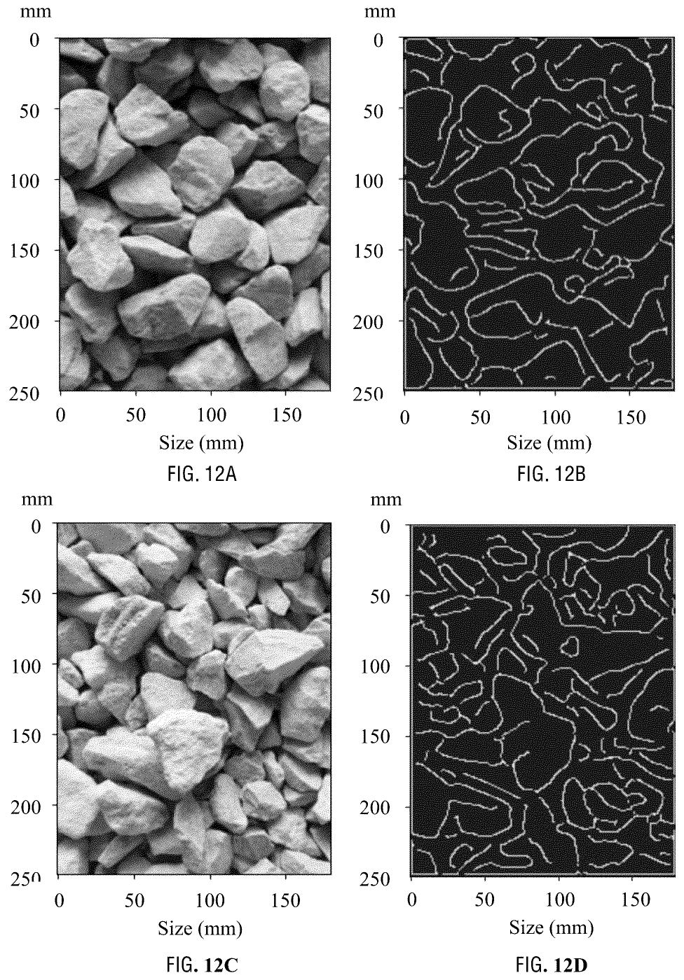

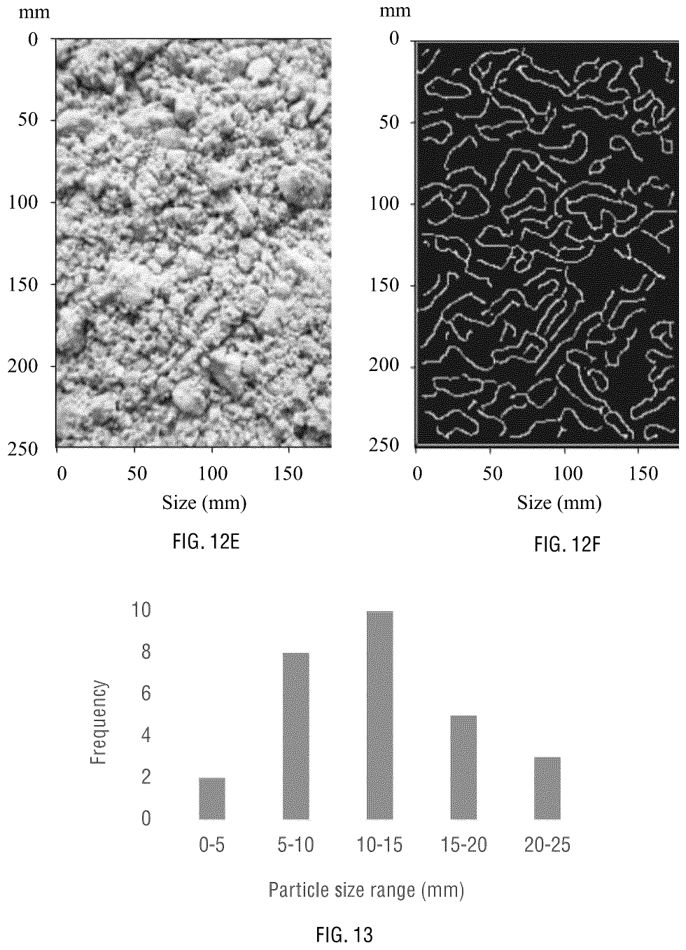

FIGS. 12A, 12C and 12E show the images of the aggregates having different sizes, recorded with a camera, while FIGS. 12B, 12D and 12F show the corresponding images processed by the AI-powered control system of the invention. This allows the computing unit to calculate the particle size distribution of aggregates.

FIG. 13 shows the particle size distribution histogram generated by the AI-powered system of the invention from these segmented images. The X-axis in this histogram represents the particle size range in millimetres, and the Y-axis represents the frequency or count of particles within each size range. The histogram bars show the distribution of particle sizes. In this example, the majority of particles fall within the 5-15 mm range, with fewer particles in the smaller and larger size ranges.

This histogram clearly shows that the received aggregates exhibit a desirable particle size distribution for concrete production. The distribution is relatively well-graded, with a good mix of different sizes. This is generally preferred for achieving optimal packing density and workability in concrete. There are no extreme peaks or gaps in the distribution, indicating a consistent and well-controlled aggregate production process.

Based on these data, the AI system further analyses and compares (correlates) the calculated values with the quality of aggregates in the preparation of fresh concrete, ready mix or precast concrete, and also warns the user if the quality of aggregates for concrete preparation is low from the very beginning of the preparation process or deteriorates in the process.

### Example 2: Identifying Impurities in Aggregates using Image Analysis

The objective of this experiment is to demonstrate how the AI-based control system uses image analysis to identify impurities within raw materials, specifically aggregates. Two samples of aggregates (transported on a conveyor belt) containing clay impurities are used in this experiment. A camera positioned above the conveyor belt to capture images of the aggregates. The AI-based control system autonomously processes and analyses the image. processing and analysis capabilities.

The experimental procedure is as follows. The aggregates are placed on the conveyor belt and transported under the camera. The camera captures high-resolution images of the aggregates as they pass by. The captured images are pre-processed by the AI system of the invention to enhance their quality and prepare them for analysis. This involves noise reduction to remove unwanted artifacts, contrast enhancement to improve the visibility of impurities, and colour correction to standardise the images.

The proactive AI-powered system uses a Convolutional Neural Network (CNN) to extract relevant features from the images. The CNN is trained to recognise patterns and characteristics associated with different types of impurities. The AI system analyses the extracted features to identify and classify impurities within the aggregates. This involves comparing the features with a database of known impurity characteristics and using machine learning algorithms to classify impurities based on their visual appearance. The identified impurities are colour-coded (marked) in red on the image to visualise their location.

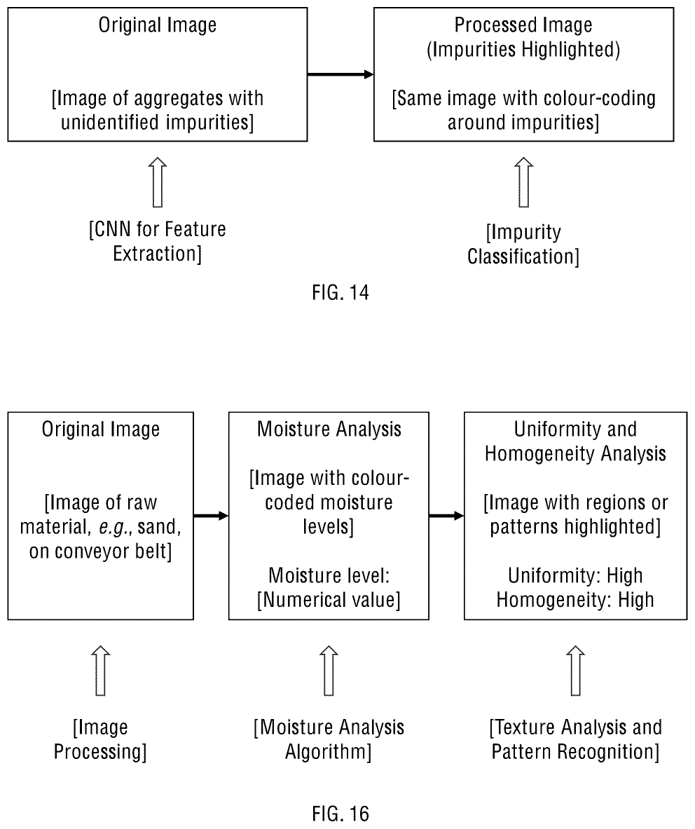

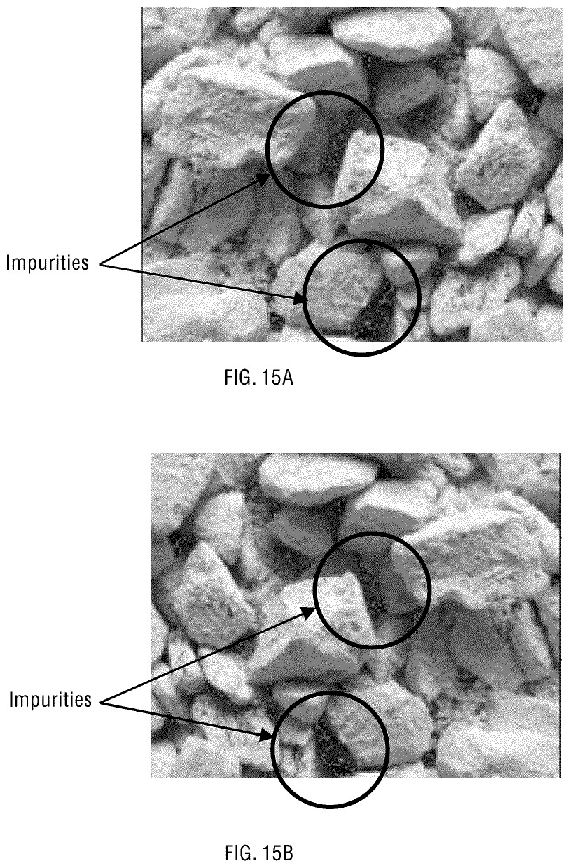

Reference is made to FIG. 14 illustrating how the AI-based control system identifies impurities within raw materials using image analysis. The figure is represented as a split-screen with two images. The left side shows the original image of aggregates with impurities. The right side shows the same image after processing with the AI-powered system, with impurities highlighted using colour-coding. The colour scheme used can be different to represent different types of impurities. For example, clay impurities may be coloured in red, organic matter may be coloured in green, and soil-in brown. FIGS. 15A and 15B show the detection of clay impurities in aggregates by detecting the changes in the hue shades of the image (indicated by the red dots in the image). As mentioned above, moisture and contaminants in the aggregates strongly affect the physical properties and workability of the concrete produced from these aggregates.

### Example 3: Moisture, Uniformity, and Homogeneity of Concrete Raw Materials

This experiment focuses on demonstrating the AI-based control system's ability to assess moisture content, uniformity, and homogeneity of raw materials using image analysis. The objective of the experiment is to showcase the AI system's capability to accurately analyse images of raw materials and extract information about their moisture content, uniformity, and homogeneity. This information is crucial for ensuring consistent concrete quality.

A representative sample of an aggregate raw material with varying degrees of moisture content and potentially some inconsistencies in uniformity and homogeneity was used in the experiment. The raw material sample was transported on a conveyor belt under the high-resolution camera positioned above the conveyor belt to capture images of the raw material. The AI-based control system was equipped with image processing, machine learning algorithms, and a trained AI model for moisture analysis, uniformity assessment, and homogeneity evaluation. Instruments for reference measuring actual moisture content (e.g., moisture meter) and assessing uniformity and homogeneity (e.g., visual inspection).

The experimental procedure is as follows. The raw material sample is spread evenly on the conveyor belt and transported under the camera. The camera captures multiple images of the material from different angles and positions. The acquired images are pre-processed to enhance their quality and prepare them for analysis. This includes noise reduction by removing any unwanted artifacts or distortions in the images, colour correction by adjusting the colour balance and contrast to standardise the images, and segmentation by separating the raw material from the background in the images.

In the performed moisture analysis, the AI system analyses the images to extract features related to moisture content. This involve analysing colour variations, texture patterns, and reflectivity. Based on the extracted features, the AI system estimates the moisture level of the raw material and provides a numerical value (e.g., percentage of moisture content).

The AI system then analyses the texture and patterns in the images to identify variations in particle size distribution, colour, or other visual characteristics that might indicate inconsistencies in uniformity. The AI system also performs the region-based analysis by dividing the image into regions and comparing the properties of these regions to assess homogeneity. It actually looks for variations in colour, texture and composition that indicates segregation or clumping of the material. Based on this analysis, the AI system provides an assessment of uniformity and homogeneity, typically as a qualitative score (e.g., “high,” “medium” or “low”). The AI system's estimations of moisture content, uniformity, and homogeneity are compared with reference measurements obtained using standard techniques. This helps to validate the accuracy and reliability of the AI system's analysis.

Reference is now made to FIG. 16 schematically showing the AI-based control system assessing moisture content, uniformity, and homogeneity of raw materials through image analysis. The figure is represented as a series of image processing and analysis steps. Each box depicts a stage in the process, with a simplified visual representation. Textual descriptions within the boxes clarify the content of each stage. Black arrows indicate the flow of the process. Annotations below the boxes describe the techniques used in each step. The final outputs are numerical values for moisture level and textual assessments of uniformity and homogeneity. Table 1 shows the results of this experiment:

| Property | Value/Assessment |
|---|---|
| Moisture Level | 5.80% |
| Uniformity | High |
| Homogeneity | High |

The numerical value (5.8% in this experiment) indicates the moisture content of the raw material, which falls within the acceptable range for concrete production. The “high” assessment for uniformity suggests that the raw material exhibits consistent properties throughout the sample, with no significant variations in colour, texture, or particle size distribution. The “High” assessment for homogeneity indicates that the raw material is well-mixed and free from segregation or clumping, ensuring a consistent composition throughout the concrete mixture. These results clearly demonstrate the AI system's ability to accurately assess the moisture content, uniformity, and homogeneity of raw materials, contributing to the production of high-quality concrete.

### Example 4: Visualizing Moisture Content in Aggregates using Image Analysis

This experiment focuses on demonstrating the AI-based control system's ability to determine the moisture content of aggregates using image analysis. Thus, the objective of this experiment is to showcase the AI system's capability to accurately estimate the moisture content of aggregates by analysing images and comparing the results with traditional moisture measurement methods.

Two sets of aggregate samples with different moisture levels were introduced for the analysis. The first set (3305) has a higher moisture content, and the second set (1989) has a lower moisture content. These aggregate samples were placed on the conveyor belt and transported under the high-resolution camera positioned above the conveyor belt to capture images of the aggregates. The camera captures images of the aggregates under consistent lighting conditions. The AI-based control system of the invention equipped with image processing capabilities, machine learning algorithms, and a trained AI model for moisture content estimation was used in this experiment. A standard instrument for measuring the reference moisture content in aggregates (e.g., oven drying method, moisture meter) was used.

The acquired images are pre-processed to enhance their quality and prepare them for analysis. This involves noise reduction to remove unwanted artifacts, colour correction to standardise the images, and segmentation to isolate the aggregates from the background.

The AI system then analyses the images to extract features related to moisture content. This involves analysing colour variations (wetter aggregates may appear darker or have a different hue compared to drier aggregates), and texture analysis, where the texture of the aggregates changes with varying moisture levels. The AI system uses the extracted features to estimate the moisture content of the aggregates. This involves comparing the features with a database of known moisture levels or using machine learning algorithms to predict moisture content based on the image characteristics. The moisture content estimations obtained from the AI system are compared with the measurements obtained using the reference moisture measurement tool. This helps to validate the accuracy and reliability of the AI system.

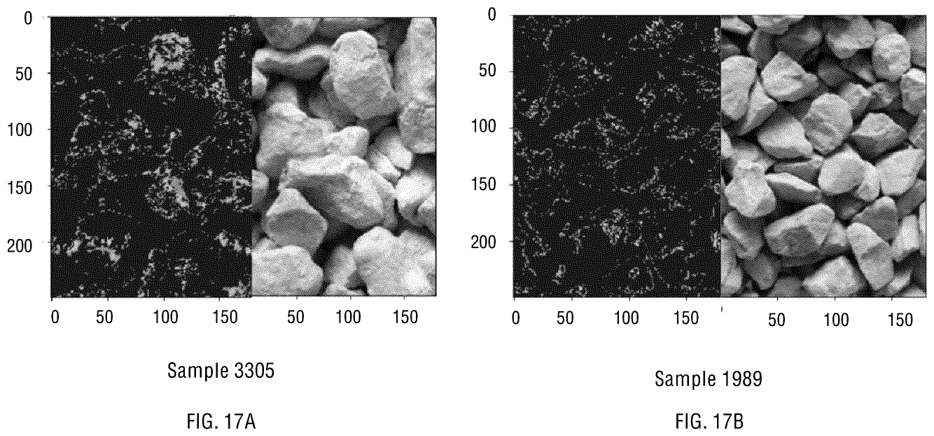

FIGS. 17A and 17B shows the results of the experiment by visualising moisture content in aggregates using AI-powered image analysis of the present invention for two samples: 3305 and 1989, respectively. The AI output (left side of each image pair) visualizes the estimated moisture distribution, while the actual image shows the corresponding visual appearance of the aggregates. This comparison helps validate the AI system's ability to accurately assess moisture content (right side of each image pair).

For the AI output of the AI system's moisture analysis (left side of each image pair), the X-axis represents the horizontal position across the image (pixels on a normalized scale), and Y-axis represents the vertical position across the image (pixels or a normalized scale). The colour variations in this part of the image represent the AI system's estimation of moisture content at different locations within the aggregate sample. Brighter colours (yellow, green) indicate higher moisture levels, whereas darker colours (purple, blue) indicate lower moisture levels.

For the actual aggregate images (right side of each image pair), the X-axis is same as above-horizontal position across the image, and Y-axis is also same as above-vertical position across the image. In this part of the image, the colour variations represent the actual visual appearance of the aggregates, with darker areas potentially indicating higher moisture content.

For Sample 3305, the AI system's output shows a larger area of brighter colours, indicating higher moisture content. This is consistent with the actual appearance of the aggregates, which appear darker and potentially wetter. For Sample 1989, the AI system's output shows a larger area of darker colours, indicating lower moisture content. This aligns with the actual image of the aggregates, which appear lighter and drier.

For conclusion, this experiment demonstrates that the AI-based control system can effectively estimate the moisture content of aggregates using image analysis. The results obtained from the AI system are consistent with the actual moisture levels of the samples and align with the observations from the reference measurements. This capability clearly enables the AI system to make informed decisions about adjusting the concrete mix design to account for variations in aggregate moisture, ensuring consistent concrete quality.

### Experiment 5: Determining Density and Structural Integrity of Raw Materials using Ultrasonic Sensors

The objective of the present experiment is to demonstrate how the AI-based control system utilises ultrasonic sensors to measure the speed of sound through raw materials and infer their density, water content, solid content in recycled water, homogeneity and structural integrity. Various raw materials used in concrete production, such as different types of aggregates, sand, and cement are tested in this experiment. Samples with known variations in density and structural integrity (e.g., cracks, voids) are included. A high-frequency ultrasonic sensor with a transmitter and receiver is used in the experiment. Data acquisition system records the ultrasonic signals and measure the time-of-flight.

The AI-based control system is equipped with signal processing capabilities and algorithms to analyse the ultrasonic data and determine density and structural integrity. Standard pycnometer is used for measuring reference density. Structural integrity is assessed using visual inspection (optionally X-ray imaging).

The ultrasonic sensor is positioned in contact with the raw material sample. Good coupling between the sensor and the material is ensured to minimise signal loss. The ultrasonic sensor transmits a high-frequency sound wave through the material. The wave travels through the material and is reflected back to the sensor's receiver. The data acquisition system accurately measures the time-of-flight (TOF), which is the time taken for the ultrasonic wave to travel through the material and return to the sensor. The speed of sound in the material is calculated using the TOF and the known distance between the sensor and the reflecting surface (or the thickness of the material).

The AI-based control system of the invention analyses the speed of sound data to infer the density and structural integrity of the material. This involves density estimation by using established relationships between the speed of sound and density for different materials; and anomaly detection by identifying variations in the speed of sound that may indicate cracks, voids, or other structural irregularities. The density and structural integrity estimations from the AI system are compared with the measurements obtained using the reference tools. This helps to validate the accuracy and reliability of the ultrasonic sensor and the AI system's analysis.

The results of this experiment are summarised in Table 2 as follows:

| | Speed of | Density | Structural |
|---|---|---|---|
| Material | Sound (m/s) | (kg/m³) | Integrity |
| Aggregate A | 5500 | 2650 | High |
| Aggregate B | 4800 | 2400 | Medium (minor cracks) |
| Sand | 1700 | 1600 | High |
| Cement | 3200 | 1450 | Low (significant voids) |

These results demonstrate how the AI-powered system of the present invention can differentiate between materials and detect variations in density and structural integrity based on the measured speed of sound. This information can be used to optimise the concrete mix design and ensure the quality and durability of the final product.

### Experiment 6: Identifying Contaminants and Raw Materials Analysis using Spectrometer

The objective of this experiment is to demonstrate the AI-based control system's ability to utilize spectrometer data to analyse the chemical composition of raw materials, identify potential contaminants, and ensure the use of correct materials in concrete production. A variety of raw materials used in concrete production, including different types of aggregates, sand, cement, and admixtures were tested in this experiment. Some samples intentionally included contaminants or incorrect materials to test the AI system's detection capabilities. An X-ray fluorescence (XRF) spectrometer (Bruker S1 Titan) capable of analysing the elemental composition of materials is used in the experiment.

The AI-based control system of the present invention is equipped with algorithms and a trained AI model to analyse spectral data, identify contaminants, and verify material composition. Standard reference materials with known chemical compositions for calibrating the spectrometer and validating the AI system's analysis are measured as well. The raw material samples are prepared for analysis according to the spectrometer's requirements. This involves grinding and pelletizing to ensure a uniform and representative sample.

The XRF spectrometer is used to analyse the elemental composition of each raw material sample. The spectrometer generates a spectrum representing the intensity of different wavelengths of light emitted or absorbed by the sample, which corresponds to the presence and concentration of specific elements. The AI-based control system analyses the spectral data to identify elements by determining the presence and concentration of various elements in the raw material; compare the spectral data with a database of known, reference spectra for different materials and contaminants; identify any unexpected elements or unusual concentrations that may indicate the presence of contaminants, and ensure that the raw material matches the expected chemical composition for its intended use in the concrete mix. If the AI system detects contaminants or identifies incorrect materials, it generates alerts to notify operators.

The results of this experiment are summarised in Table 3 as follows:

| Material | Expected Composition | Detected Composition | AI System Assessment |
|---|---|---|---|
| Aggregate A | Primarily SiO₂, Al₂O₃ | SiO₂, Al₂O₃, trace Fe | Correct material |
| Sand | Primarily SiO₂ | SiO₂, trace Al₂O₃, Fe | Correct material |
| Cement | CaO, SiO₂, Al₂O₃, Fe₂O₃ | CaO, SiO₂, Al₂O₃, Fe₂O₃, high S | Contaminated |
| | | | (excess sulphur) |
| Admixture | Specific organic | Unexpected inorganic | Incorrect |
| | compounds | compounds | material/contaminated |

The table shows how the AI-powered system of the invention can accurately identify the elemental composition of raw materials and compare it with expected values. In the case of the cement sample, the AI system of the invention detects a high concentration of sulphur, indicating potential contamination. This could be due to the presence of gypsum or other sulphur-containing impurities, which can affect the setting time and durability of concrete. For the admixture sample, the AI system detects unexpected inorganic compounds, suggesting that the wrong material or a contaminated batch was supplied. This could significantly alter the properties of the concrete and lead to performance issues.

To sum up, by utilising spectrometer data and AI-powered analysis, this system can identify potential contaminants and ensure the use of correct materials, contributing to the production of high-quality and reliable concrete.

### Example 7: Benefits of Sensor Fusion in Concrete Quality Control

The objective of this experiment is to showcase how the AI-based control system leverages data fusion from multiple sensors to achieve more accurate and robust quality control in concrete production compared to using single sensor modalities. A variety of raw materials with known variations in properties, including aggregates with varying moisture content and size distribution, cement with potential contaminants, and admixtures with potential inconsistencies were used in this experiment.

The multi-sensor system of the present invention includes:
Cameras for image analysis.
Ultrasonic sensors for density and structural integrity assessment.
Spectrometers for chemical composition analysis.
Temperature sensors.

The AI-based control system is equipped with data fusion algorithms, machine learning models (CNNs, RNNs, MLPs), and a trained AI model for comprehensive raw material analysis and concrete mix adjustment. Concrete mixer is used for preparing concrete mixtures, and concrete testing equipment is used in this experiment to measure properties of the produced concrete, such as slump, compressive strength, and setting time.

The experimental procedure is as follows. The raw material samples are placed on the conveyor belt and transported through the sensor system. Data is simultaneously acquired from all sensors: images, ultrasonic signals, spectral readings, and temperature readings. Data from each sensor is independently analysed using the AI system, as follows:
Image Analysis estimate moisture content, particle size distribution, and identify impurities in aggregates.
Ultrasonic Analysis determines density and structural integrity of aggregates.
Spectrometer Analysis identify contaminants and verify the chemical composition of cement and admixtures.
Temperature Analysis monitors the temperature of raw materials.

The data from all sensors is fused using the AI system's fusion algorithms (e.g., feature embedding, attention mechanism and MLP fusion network), and a comprehensive representation of the raw material properties is created. The fused data and the AI models (supervised and reinforcement learning) are used to predict concrete properties and make decisions about adjusting the concrete mix design. The raw material ratios and admixture additions are then adjusted based on the AI's recommendations.

Concrete mixtures is prepared using both individual sensor analysis (adjustments based on each sensor independently), and fused sensor data analysis (adjustments based on the combined information from all sensors), and the properties of the produced concrete (slump, strength, setting time) are tested. Finally, the properties of the concrete produced using individual sensor analysis versus fused sensor data analysis are compared. The accuracy, consistency, and efficiency of concrete production are evaluated in both scenarios.

The results of this experiment are summarised in Table 4 as follows:

| | | Compressive | |
|---|---|---|---|
| | | Strength | Setting Time |
| Analysis Method | Slump (mm) | (MPa) | (hours) |
| Individual Sensor Analysis | 100 ± 15 | 30 ± 5 | 8 ± 2 |
| Fused Sensor Data Analysis | 110 ± 5 | 35 ± 2 | 10 ± 1 |

The table shows that the concrete produced using fused sensor data analysis exhibits higher slump (improved workability), higher compressive strength and more consistent setting time. This demonstrates the benefits of data fusion in providing a more complete understanding of the raw materials and enabling more precise adjustments to the concrete mix. The AI system can leverage the complementary information from different sensors to overcome limitations of individual sensor modalities and achieve more accurate and robust quality control. This experiment highlights the advantages of sensor fusion in enhancing concrete quality control, leading to improved concrete properties, consistency, and efficiency in production.

### Experiment 8: Comparing Proactive, Reactive, and No-AI Approaches in Concrete Quality Control

The objective of this experiment is to demonstrate the advantages of the proactive AI-based control system of the invention in maintaining concrete quality and efficiency compared to a reactive AI system and a traditional system with no AI.

A variety of raw materials with known variations in properties, including aggregates with varying moisture content and size distribution, cement with potential contaminants, and admixtures with potential inconsistencies were used in this experiment. Concrete mixer is used for preparing concrete mixtures, and concrete testing equipment is used to measure properties of the produced concrete, such as slump, compressive strength, and setting time.

The multi-sensor system of the present invention includes:
Cameras for image analysis
Ultrasonic sensors for density and structural integrity assessment
Spectrometers for chemical composition analysis
Temperature sensors

Control systems compared in this experiment are:
1) Proactive AI System: The AI system described in the present invention, capable of autonomously adjusting the concrete mix in real-time based on sensor data.
2) Reactive AI System: An AI system that analyses sensor data and generates alerts but requires manual intervention for adjustments to the concrete mix.
3) No-AI System: A traditional control system with no AI capabilities, relying solely on manual adjustments based on operator experience and periodic testing.

The experimental procedure is as follows. Multiple concrete mixtures are prepared using the same target mix design but with varying raw material properties. Concrete batches are produced using each of the three control systems: proactive AI, reactive AI, and no AI. For the proactive AI of the invention, the AI system is allowed to autonomously monitor sensor data, generate alerts, and adjust the concrete mix in real-time. For reactive AI, the AI system's alerts are monitored, and the concrete mix is manually adjusted based on the recommendations. Finally, for “No AI”, an operator relies on experience and periodic testing of the concrete mixture to make manual adjustments. The properties of the produced concrete (slump, strength, setting time) are measured for each control system, and the number of alerts generated, the frequency of manual adjustments, and the time taken to achieve the target concrete properties are recorded.

The concrete properties achieved by each control system are then compared by analysing the efficiency of each system in terms of the number of alerts, manual adjustments, and time taken to achieve the target properties, and the consistency and variability of concrete quality across different batches for each system are evaluated. The results of this experiment are summarised in Table 5 as follows:

| | Avg. | Avg. | Avg. | | | |
|---|---|---|---|---|---|---|
| | Slump | Strength | Setting | | | |
| | Devia- | Devia- | Time | | Manual | Time to |
| Control | tion | tion | Deviation | | Adjust- | Target |
| System | (mm) | (MPa) | (hours) | Alerts | ments | (minutes) |
| Proactive | ±3 | ±1 | ±0.5 | Low | Minimal | 5 |
| Al | | | | | | |
| Reactive | ±8 | ±3 | ±1.5 | High | Frequent | 15 |
| Al | | | | | | |
| No Al | ±12 | ±5 | ±2 | N/A | Very | 30 |
| | | | | | Frequent | |

The table shows that the proactive AI system achieves the most consistent concrete quality with minimal deviations from the target properties. It also generates fewer alerts, requires minimal manual adjustments, and achieves the target properties faster compared to the reactive AI and no-AI systems. The reactive AI system shows some improvement over the no-AI system, but still requires frequent manual intervention and results in greater variability in concrete quality. The no-AI system exhibits the highest deviations from the target properties, the most frequent manual adjustments, and the longest time to achieve the desired concrete quality.

With particular regard to “Time to Target” in the table, this term refers to the time taken for each control system to achieve the target concrete properties. This is a measure of the efficiency of each system in adjusting the concrete mix and reaching the desired quality. In the results of this experiment, the proactive AI system takes only 5 minutes to reach the target properties, while the reactive AI system takes 15 minutes and the “no-AI” takes 30 minutes. This highlights the efficiency and speed of the proactive AI system in optimizing the concrete mix compared to the other approaches.

This experiment demonstrates the significant advantages of the proactive AI-based control system in optimizing concrete production. Its ability to autonomously monitor, analyse, and adjust the concrete mix in real-time leads to improved concrete quality, consistency, and efficiency compared to reactive or manual approaches.

1. A system for real-time, autonomous quality control of raw materials used in concrete production, comprising:
1. A sensor system configured to monitor properties of the raw materials, the sensor system including at least two sensors selected from a camera, an ultrasonic sensor, a spectrometer, and a temperature sensor; and
2. A proactive artificial intelligence (AI)-based control system configured to:
receive real-time sensor data from the sensor system;
analyse the real-time sensor data to determine one or more properties of the raw materials, the properties including water content, solid content density, particle size distribution, impurities, temperature, homogeneity, hardness, shape, and colour of the raw materials; and
autonomously generate an alert and adjust a concrete mixture in response to the real-time sensor data without requiring user intervention,
wherein the proactive AI-based control system is configured to adjust the concrete mixture by adjusting a ratio of the raw materials and by controlling addition of admixtures according to a structured process and according to the data received from the sensor system.

2. The system of claim 1, wherein the raw materials include at least one of coarse aggregates, fine aggregates, sand, cement, fly ash, and other powder additives, water and recycled water, and all types of chemical admixtures used in the concrete plant.

3. The system of claim 1, wherein the proactive AI-based control system is further configured to adjust the concrete mixture based on loading time.

4. The system of claim 1, wherein the AI-based control system includes a camera configured to capture images of the raw materials, the AI-based control system being configured to analyse the images to:
(i) determine particle size distribution of the raw materials; and/or
(ii) identify impurities within the raw materials; and/or
(iii) assess moisture content, uniformity, and homogeneity of the raw materials and deviation from defined values.

5. The system of claim 1, wherein the AI-based control system includes an ultrasonic sensor configured to measure a speed of sound through the raw materials to determine density and structural integrity of the raw materials.

6. The system of claim 1, wherein the AI-based control system includes a spectrometer configured to determine a chemical composition, changes in colour and shade, uniformity, and homogeneity of the raw materials and deviation from defined values.

7. The system of claim 1, wherein the AI-based control system is configured to:
a) Continuously monitor the properties of various raw materials, including coarse and fine aggregates, sand, cement, fly ash, other powder additives, water, recycled water, and all types of chemical admixtures;
b) Analyse the real-time data from the sensor system to determine properties such as water content, solid content density, particle size distribution, impurities, temperature, homogeneity, hardness, shape, and colour of the raw materials;
c) Generates alerts to notify operators of potential issues, if any deviations from the desired specifications are detected; and
d) Autonomously adjust the concrete mixture without requiring user intervention by adjusting the ratio of raw materials in the mixture, controlling the addition of admixtures to modify the properties of the concrete, and taking into account the loading time of the concrete mixture.

8. The system of claim 1, wherein the AI-based control system is equipped with data fusion algorithms designed to fuse data from multiple sensors to enhance concrete quality control, leading to improved concrete properties, consistency, and efficiency in production.

9. The system of claim 1, wherein the sensors are located at one or more of receiving points for the raw materials, the yard of the plant designated for receiving raw materials, storage tanks, storage cell conveyor belts, and water and additive and admixtures lines.

10. A method for real-time, autonomous quality control of raw materials used in concrete production, comprising:
I. Monitoring, using a sensor system, properties of the raw materials, the sensor system including at least two sensors selected from a camera, an ultrasonic sensor, a spectrometer, and a temperature sensor;
II. Analysing, using a proactive artificial intelligence (AI)-based control system, real-time sensor data from the sensor system;
III. Determining, using the proactive AI-based control system, one or more properties of the raw materials, the properties including water content, solid content, homogeneity, colour, hardness, density, particle size distribution, impurities, and temperature of the raw materials; and
IV. Autonomously generating an alert using the proactive AI-based control system in response to the real-time sensor data without requiring user intervention,
wherein the AI-based control system adjusts a concrete mixture by adjusting a ratio of the raw materials and by controlling addition of admixtures according to a structured process and according to the data received from the sensor system.

11. The method of claim 10, wherein the raw materials include at least one of coarse aggregates, fine aggregates, sand, cement, fly ash, and other powder additives, water, recycled water, and chemical additives and chemical admixtures.

12. The method of claim 10, further comprising adjusting the concrete mixture by changing the composition of coarse and fine aggregates, sand, cement, coal ash, and other mineral additives.

13. The method of claim 10, wherein the AI-based control system includes a camera, the method further comprising capturing images of the raw materials and analysing the images to determine particle size distribution of the raw materials.

14. The method of claim 10, wherein the AI-based control system includes a camera, the method further comprising capturing images of the raw materials and analysing the images to identify impurities within the raw materials.

15. The method of claim 10, wherein the AI-based control system includes a camera, the method further comprising capturing images of the raw materials and analysing the images to assess moisture content of the raw materials.

16. The method of claim 10, wherein the AI-based control system includes an ultrasonic sensor, the method further comprising measuring a speed of sound through the raw materials to determine density and structural integrity of the raw materials.

17. The method of claim 10, wherein the AI-based control system includes a spectrometer, the method further comprising determining a chemical composition of the raw materials.

18. The method of claim 10, further comprising:
(i) receiving the raw materials at a receiving point;
(ii) placing the raw materials on a conveyor belt; and
(iii) adding water and additives to the raw materials at a water and additive line.

19. The method of claim 10, wherein the produced concrete is selected from the group consisting of ready-mix concrete; precast concrete; concrete produced on a 3D printer; and geopolymer concrete that does not contain cement.

20. A computer program product comprising a non-transitory computer-readable medium storing instructions which, when executed by a processor, cause the processor to perform the method of claim 10.
